(19) United States
(12) Patent Application Publication
(10) Pub. No.: US 2022/0382848 A1
(43) Pub. Date: Dec. 1, 2022

(54) Human Verification Based on Trans-Saccadic Memory

(71) Applicants: Dinesh Kanadia, London (GB); Prakash PATEL, London (GB); Neil SHAH, London (GB); Seyedmohammadreza SAADATBEHESHTI, London (GB)

(72) Inventor: Seyedmohammadreza SAADATBEHESHTI, London (GB)

(21) Appl. No.: 17/755,865

(22) PCT Filed: Nov. 11, 2020
(86) PCT No.: PCT/GB2020/052868

§ 371 Date: May 10, 2022

(30) Foreign Application Priority Data
Nov. 11, 2019 (GB) 1916413.6
Dec. 18, 2019 (GB) 1918688.1

(51) Int. Cl. G06F 21/36; H04L 9/32

(52) U.S. Cl. CPC G06F 21/36; H04L 9/3213; G06F 2221/2133

(57) ABSTRACT

The present invention relates to a method, apparatus, and system of distinguishing a human user and a simulated user. More particularly, the present invention relates to protecting networks against simulated human users via an image recognition arrangement. Aspects and/or embodiments seek to provide a method and system for verifying that a user is human, rather than a computer, in order to protect access to resources such as public facing websites.

### FIELD

The present invention relates to a method, apparatus, and system of distinguishing a human user and a simulated user. More particularly, the present invention relates to protecting networks against simulated human users via an image recognition arrangement.

### BACKGROUND

Some networks may be used by both human users and users simulated by machines, these simulated users also referred to as “bots”. Some simulated users may be malicious in nature, for example by repeatedly making computationally expensive requests to a server and slowing down the network for other legitimate users. A large number of malicious simulated users can be created to cause damage to a network and perhaps even in order to block other human users from accessing the network.

In order to limit the potential damage to the operations of a network from simulated users, a barrier may be installed arranged to block simulated users but allow human users. For example, in order to gain access to a network, a brief description may be required of an unclear image, or a user may be required to input a sequence of letters displayed in an unclear fashion. Such tasks are usually relatively straightforward for a human user, but may be very difficult to complete for a simulated user (or at least slows down simulated users from accessing the network, or increases the computational power required to simulate each user thus increasing the difficulty of operating the number of simulated users required to damage or prevent access to a targeted network).

One conventional example of such a barrier arrangement is known as a “Completely Automated Public Turing test to tell Computers and Humans Apart”, or “CAPTCHA”. This test provides one or more words in a distorted font, which is used as a password to access the network. Successful entry of the one or more words demonstrates the user to be human and hence legitimate. CAPTCHA arrangements are generally fully automated and so require very limited human maintenance or involvement to manage.

Another example of a conventional CAPTCHA arrangement is to present a segmented image, with one or more segments of the segmented image aligned incorrectly and/or mis-placed, as a test for an end-user to re-align or correct back to its original image which will help determine whether the user is a legitimate human user.

However, these methods can be bypassed by a simulated user to train a model that can complete the tests posed to the simulated user with sufficiently high accuracy to pass the barrier.

### SUMMARY OF INVENTION

Aspects and/or embodiments seek to provide a method and system for verifying that a user is human, rather than a computer, in order to protect access to resources such as public facing websites.

According to a first aspect, there is provided a method of determining whether a user on a client device is human or simulated, wherein the following computer implemented method is performed by a server: receiving a challenge request, wherein the challenge request comprises a request from the client device to send a challenge to the user of the client device; generating substantially instantaneously, in response to the challenge request, a sequence of challenge images for transmission, wherein generating the sequence of challenge images comprises: generating a sequence of original images comprising samples of a recognisable image; generating a plurality of random images; and interleaving the sequence of original images and the random images wherein the recognisable image is recognisable by sequential human visual perception when the sequence of challenge images are observed by a human user; transmitting each of the sequence of challenge images to the client device substantially instantaneously following generation of each of the sequence of challenge images; receiving a response to the transmitted sequence of challenge images from the client device; and determining whether the user of the client device is human or simulated from the received response being correct or incorrect.

A simulated user may comprise an automated computer program, also referred to as an automated computer script. Such simulated users are often used dishonestly or otherwise maliciously to negatively affect a network and the linked human users. The arrangement disclosed makes use of the human characteristic of “Tans-Saccadic Integration” which is sometimes referred to or based on the principles of “persistence of vision”. This allows human users to recognise an particular image within a sequence of challenge images, and hence can provide a verification tool to allow human users to respond with a correct recognition of the recognisable image whilst an automated computer (for example, a bot) cannot determine the recognisable image due to not being able to use persistence of vision. A typical human eye is able to superimpose and integrate a plurality of images together and according to the difference in the density of the pixels in an original image compared to the pixels in a random image, hence would be able to see the hidden image and/or random characters. These characters may be hidden to a simulated user owing to the current lack of sophistication in computer recognition.

In this embodiment, a sequence of challenge images is generated substantially instantaneously, and can thereby allow for an efficient process for generating challenge images across a large number of users simultaneously. This challenge can be generated on a separate security server, which may be remote from a client server or a client device. This improves the ability to scale the verification method and improve security measures. It is appreciated that the method of determining whether a user on a client device at a client side of a network is human or simulated may be performed by a server at the server side of the network but that different network configurations and server system configurations will be available.

Optionally, the challenge image comprises a verification tool. Optionally, the original images and/or recognisable image comprises any or any combination of a word; one or more letters; one or more numbers; a combination of random letters and numbers; a Completely Automated Public Turing test to tell Computers and Humans Apart (CAPTCHA) sample; a mathematical problem; a word problem; a social media link; a timer; and/or a honeypot arrangement.

The original images and/or recognisable image referenced above may provide a means for separating human and digital users. In one example, the challenge images may comprise a combination of random letters and numbers which are difficult for digital character recognition software to distinguish (for example using a dictionary attack) but less difficult for a human user. Such a combination of random letters and numbers may be written in an unusual or warped font, but still legible to a human. In a further example, a mathematical or word problem may be presented, for example a simple arithmetic calculation or a simple question about the weather. A bot would have to understand the question being asked, and then enter an appropriate result (optionally within a predetermined time frame). This would require a more advanced bot, and hence may protect the network from lower-level bots while remaining accessible to the majority of human users. A honeypot arrangement would provide a verification step which was easy for a computer but difficult for a human, which would then allow any successful completion of the test to be identified as a bot. Optionally, the recognisable images are not selected from a pool of pre-stored images as this arrangement introduces a layer of vulnerability. Instead, the recognisable images are generated in real-time.

Optionally, the recognisable image is sampled at a predetermined rate to create a plurality of original images. Optionally, the plurality of random images are generated through the use of a random function.

By creating a plurality of sampled images, random images may be interspersed in order to block a bot while allowing a human user to view the recognisable image. A random function may make the random images less susceptible to decryption or other cyber-attacks.

Optionally, the rate at which the recognisable image is rate at which the recognisable image is sampled and the rate at which the background noise is injected into the plurality of original images correspond to a fixed ratio. Optionally, the fixed ratio is the Golden Ratio to within a predetermined level of tolerance. The “Golden Ratio” (GR) is a mathematically defined constant approximately equal to: GR=1.618. It is appreciated that different levels of accuracy may be employed in different embodiments, for example using a fixed ratio of between 1.5-1.7.

Optionally, the method described herein further comprises: generating a seed value, comprising a random number between 0 and 1; comparing the seed value to a threshold value; and if the seed value is below or equal to the threshold value, generating one of the sequence of original images; else if the seed value is above the threshold value, generating one of the random images. Optionally, the probability of a challenge image appearing in a sequence comprising one or more challenge images and one or more random images is between 25% and 45%. Optionally, the delay between a first and one or more subsequent challenge images and/or random images is less than 40 milliseconds.

Persistence of vision is a characteristic that is available to a human's visual and memory system, but which is not available to computer vision systems. By studying and analysing this characteristic, the process of the example embodiment is proposed in order to distinguish between human users and computer simulated human users. Current computer techniques such as optical character recognition (OCR) do not have this sophistication, therefore those users who are able to provide the correct verification or challenge code can be classified as humans with a high degree of certainty and those users that cannot enter the correct verification or challenge code can be classified as computer simulated human users with a substantially high degree of certainty (perhaps requiring further authentication processes to be followed, for example).

By keeping the original images and random images within a predetermined ratio and displayed for a predetermined amount of time, persistence of vision of a human user may be used most effectively to transmit the required information. Presenting the sequence of (original) images to a user in rapid succession can result in persistence of vision effects for the user, allowing them to understand the recognisable character or image to be recognised and then enter the correct challenge response in order to verify themselves as a human user. The random frames are presented to the user in a completely random order. However, the percentage of the background noise is the same percentage as that of the recognisable image background noise. This helps ensure that a simulated user is not able to distinguish random frames from original frames (which are derived from the recognisable image). In contrast, a human eye would be able make such a distinction and hence recognise the recognisable image.

Optionally, there is a step of transmitting, in response to the request for a challenge image, one or more further sequences of challenge images to the client. Optionally, the one or more further sequences of challenge images are presented substantially concurrently to an initial set of challenge images.

Optionally, the challenge request comprises validating at least a client domain name and a client public key. In this way the server system validates two aspects of the client device that has made the request to ensure that client device can be trusted.

Optionally, an encrypted token is generated upon validating the response to the transmitted sequence of challenge images from the client device. Once the user is confirmed to be a legitimate human user after completing the image challenge, the server generates a token to add an addition layer of security between the server and the client device.

Optionally, the encrypted token is a one-time use token and is digitally signed using a signature key corresponding to the server. The token is issued with a signature of the server, which is usually a key of a security module within the server, and the token is operable to be used only once by the client device to avoid the possibility of hijacking or spoofing.

Optionally, there are the addition steps of sending the encrypted token to the client device; receiving from the client device an updated encrypted token comprising a signature key of the client device; and verifying the authenticity of the updated encrypted token. As a result of these steps, the client device key is checked together with the server key to ensure that there have been no unwarranted changes between what was initiated as the client device to begin with.

To enhance security, more than one challenge image may be used. That way, even if a single challenge image is successfully deciphered by a bot or similar undesired visitor, other challenge images remain to prevent unauthorised access. For example, multiple separate challenge images may be presented on different user-facing parts of a single web page, or on successive pages, all of which must be successfully navigated by entering the correct characters in order for access to be authorised.

According to a further aspect, there is provided a computer implemented method of determining between a human user and simulated user, comprising the following steps: selecting at least one recognisable image; generating a sequence of original images comprising samples of the recognisable image; generating, substantially instantaneously, a sequence of challenge images based on a first plurality of first images and a second plurality of second images, wherein the sequence of challenge images comprises a substantially interleaved sequence of the first plurality of first images and the second plurality of second images; wherein, the first plurality of first images comprises the sequence of original images; wherein, the second plurality of second images comprises a plurality of random noise images; and displaying the sequence of challenge images in a manner to cause the recognisable image to be recognisable by sequential human visual perception, when the sequence of challenge images are observed by a human user; capturing the input from the user; the input comprising the user impression of the recognisable image; and outputting a verification result based on whether the user input matches the recognisable image.

### BRIEF DESCRIPTION OF DRAWINGS

Embodiments will now be described, by way of example only and with reference to the accompanying drawings having like-reference numerals, in which:

FIG. 1 shows a flowchart of a process for generating a sequence of challenge images for display to a user, using a single stack generator using double variables, for verification that the user to which the challenge images are displayed is a human rather than a computer, according to an embodiment;

FIG. 2 shows an illustration of the sequence of images generated by the single stack generator according to an embodiment;

FIG. 3a shows the first in a set of example images to illustrate the types of images generated by the system of FIG. 1, the first image showing the object to be displayed to the user according to an embodiment;

FIG. 3b shows the second in a set of example images to illustrate the types of images generated by the system of FIG. 1, the second image showing the sampled version of the first image according to an embodiment;

FIG. 3c shows a set of example images to illustrate the types of images generated by the system of FIG. 1, the third image showing a random set of scrambled pixels to show to a user according to an embodiment;

FIG. 4 shows the effect of trans-saccadic memory on how much visual information is retained over time after it has been displayed to a human;

FIG. 5 shows the effect of trans-saccadic memory between two images being shown to a human user, illustrating a long time gap between images being displayed to the human user;

FIG. 6 shows the effect of trans-saccadic memory between a sequence of images shown to a human user where there is a short time interval between the display of images to the human user;

FIG. 7 shows a an embodiment of the single stack generator rendering a series of images using a variable A;

FIG. 8 shows an example representation of how consecutive images are presented within an acceptable time range, and the sequence of images shown to a user along with an example order of original frames and random frames, according to an example embodiment;

FIG. 9 shows an alternative embodiment of the single stack generator using only a single variable.

FIG. 10 shows an example embodiment of an authentication process using a human verification approach;

FIG. 11 shows a conventional security model;

FIG. 12 shows another embodiment of the authentication process using “three-dimensional” multi-factor authentication combined with human verification;

FIG. 12a shows another representation of the authentication process of FIG. 12 where a human user is verified by the system;

FIG. 12b shows another representation of the authentication process of FIG. 12 where a bad actor is prevented from accessing a client database;

FIG. 12c shows another representation of the authentication process according to another embodiment;

FIG. 13 shows a super-imposing and sub-super-imposing mechanism according to a trans-saccadic integration process according to an embodiment.

### SPECIFIC DESCRIPTION

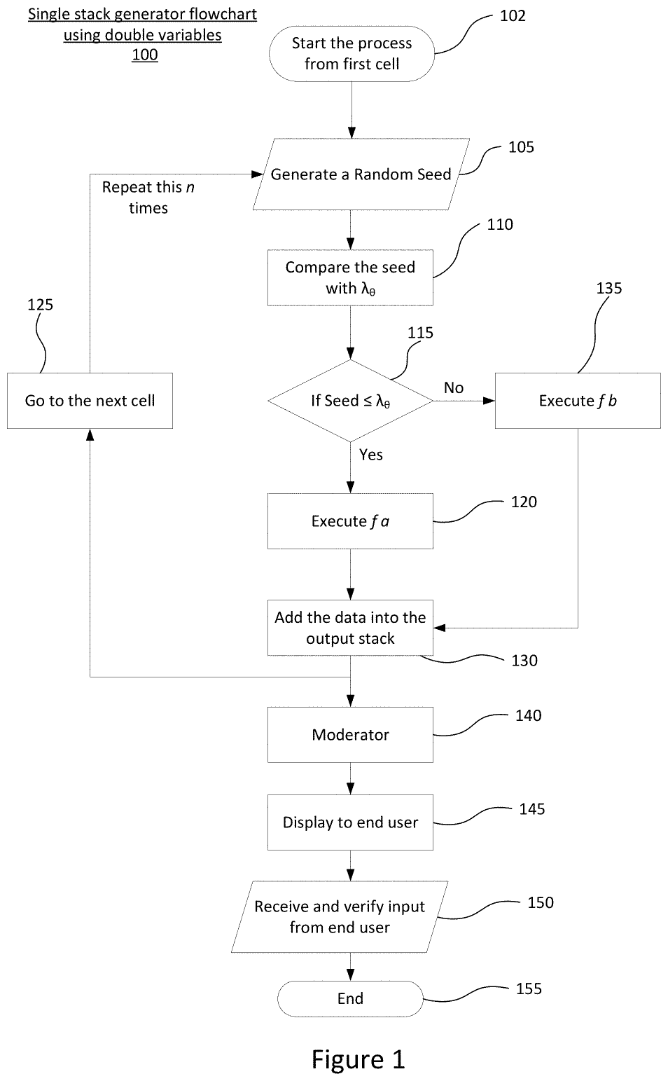

Referring to FIG. 1, an example embodiment of a single stack generator using double variables will now be described.

The example embodiment is a process 100 for providing a security interface for the verification of genuine human users of computer services. This is a process that can be used as a protective barrier to network access, for example on websites and online service providers, against automated computer operations masquerading as human users (also commonly known as bots or simulated users).

The process 100 in the example embodiment uses characteristics of the human visual and sensory memory (SM) system as part of the verification process, specifically the characteristic commonly termed “persistence of vision”. In addition, the human visual system also uses a sophisticated algorithm that can form a complete picture of an object in ones “Trans-Saccadic Memory” (TSM). Since the human visual system is much more sophisticated than any corresponding conventional computer processes, it is anticipated that only humans will be able to decipher or understand the test required to verify that a user is genuinely human as using the process described in the example embodiment will generate a persistence of vision/TSM effect that can allow a human user to enter a verification or challenge code in response but should not allow a simulated human user, i.e. a bot, to decipher the verification or challenge code in order to continue the pretense of being a human user.

The human eye relies on analogue signals that are processed in the trans-saccadic memory while computers are entirely digital, working in binary digits of 0's and 1's. Computers, being based on a binary system, cannot understand or decipher a series or sequence of analogue images (flashed) created by embodiments described herein. Only human users can read and understand the analogue images and with relative ease.

Rapid eye movements, typically known as saccadic movements, are necessary for human visual systems in order to perceive a high-quality image from the surrounding environment through integration and fusion of visual information. During trans-saccadic eye movements, there are intervals called fixations, which last for approximately 300 milliseconds.

Thus, TSM is the neural process that allows humans to perceive their surroundings as a seamless, unified image, despite rapid changes in fixation points. Human eyes move rapidly and repeatedly, focusing on a single point for only a short period of time before moving to another point. A final image that is interpreted by a human is based on the density function of the partially presented frames at very high speed.

At least some of the embodiments and aspects presented herein are based on the abilities of the human visual system to retain and superimpose (and sub-superimpose) the images of a sequence, in order to make up or render the final image of an object.

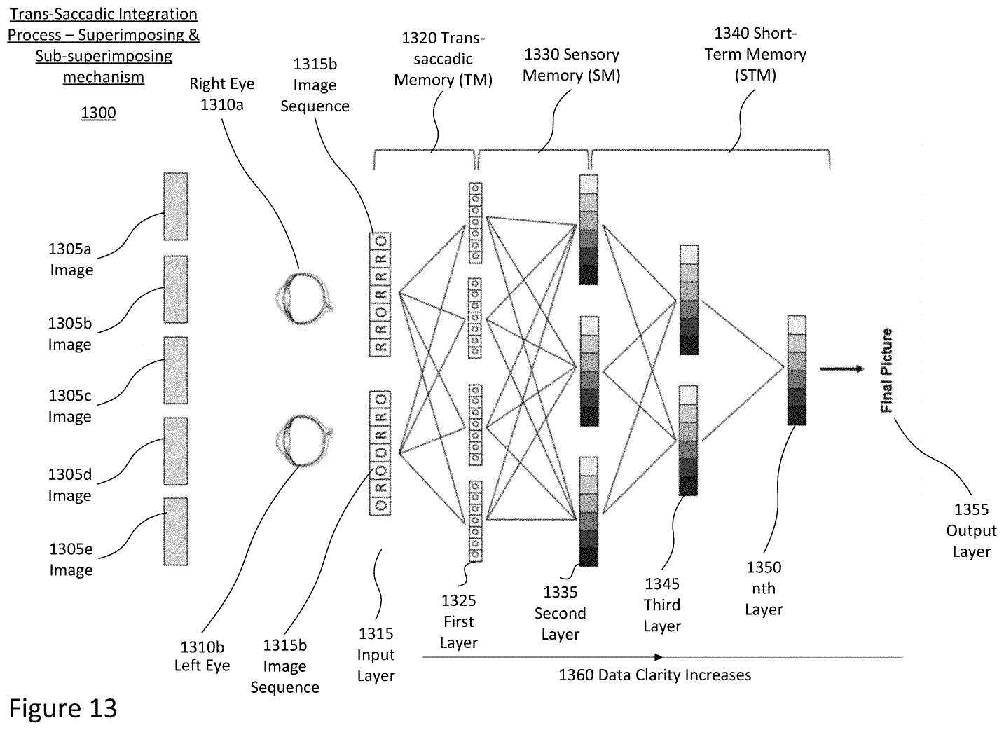

Referring briefly to FIG. 13, the mechanism of trans-saccadic data integration processed by a human brain is illustrated.

Where several fleeting images 1305a-e are shown to a user in rapid sequence, the image information is received by the eyes 1310a,1310b of the user and shall be treated as the image sequence 1315b shown in an “input layer” 1315 where “0” represents a sampled original image and “R” represents a random noise image. Any of the fleeting images 1305a-e may be random or sampled original images and the sequence of sampled original and random images shown as the fleeting images 1305a-e will be received as the sequence of images 1315b in the “input layer” 1315 of the brain of the user.

First, all the frames 1315b will be superimposed and filtered for recognisable data inside “Trans-saccadic memory” 1320 during each fixation. Then, the output result of each fixation will be compared with the output results of the each fixation, shown as a sequence of layers 1315,1325,1335, 1345,1350. This repetition process will make the data clearer 1360 and improve accuracy for human brain's neural network to “see” (i.e. recognise) the image behind the sequence of fleeting images 1305a-e, for example, as proposed in embodiments herein. The more this process is carried out and the more cycles of processing the human brain carries out for the data, the clearer the output results will be. This is fundamentally why it is in human nature to stare at the flashing images; so a human can more easily recognise a recognisable image, characters embedded within noise, or behind the flashing images, etc. In the viewer's brain, the data from sensory memory 1330 will be passed to short-term memory 1340. Embodiments of the present invention have been developed in such a way that the duration of frames will only engage with a viewer's short-term memory 1340 and substantially no information will be stored in a viewer's long-term memory.

Returning to FIG. 1, the process 100 of the example embodiment as shown in FIG. 1 uses a mathematical algorithm which produces and renders a series of randomly generated frames (i.e. a sequence of images) at a very high frequency. The output result of displaying this series of random frames would cause an optical illusion to a human user but not a computer user using known computer vision or optical character recognition techniques.

The proposed process 100 of the example embodiment is based on generating and rendering a series of randomly generated frames, with each random frame rendered using a specific threshold value and specific rate of frames per second (FPS), such that the result may be superimposed and read by a human eye.

In the process of the example embodiment, the production of these series of images uses an architecture referred to as a “single stack generator” which uses the process 100 illustrated in FIG. 1. In this approach 100, a sequence of images is produced and rendered substantially instantly and substantially in real-time to a user using a threshold parameter Δ_{θ}.

The process 100 starts the process with a first image (or cell or frame) to be generated in step 102, there being a pre-defined number of images in a sequence needing to be generated.

Next a random seed 105 is generated for each image in the sequence of challenge images being created for display to a user.

The random seed generated in step 105 is then compared 110 with the threshold value λ_{θ} and in a step 115 different images are chosen to be generated if the seed that is generated in step 105 is larger or smaller than the threshold value λ_{θ}. If the seed that is generated in step 105 is equal to or smaller than the threshold value λ_{θ} then function-A 120 is executed; but if the seed that is generated in step 105 is larger than the threshold value λ_{θ} then function-B 135 is executed.

Two things follow the selection of which of functions -A 120 or -B 135 are executed: the process repeats to create the subsequent images in the sequence; and the output of executing functions -A 120 or -B 135, i.e. the random or original image generated for the current point in the sequence of images (depending on the value of the random seed) is added to the output “stack” for processing by the moderator module 140 and then display in sequence to the end user 145. In effect, as the random or original images are generated, they are then processed and transmitted to the user substantially immediately (subject to any minor delays introduced by internal processing and moderation) in sequence without the system having to wait for the entire sequence of images to be created before beginning transmission of the entire sequence to the user.

The moderator module 140 ensures a predetermined, optionally optimal, delay (or range of permitted delay intervals) occurs between each image being displayed to the user in a generated series of images. Without the moderator module 140 some images may arrive sooner and some later owing to conventional limitations of the network used. Therefore, the moderator module 140 is operable to hold one or more images and then transmit them to a user in order that at the client device the images are displayed substantially evenly and with a substantially appropriate delay between the display of each image in the sequence. The moderator module 140 may also monitor the speed of an Internet connection used, and if the speed is not sufficient to play the live images, it combines all the rendered images with the optimal delays in the form of a single GIF file and then transmits that to a client.

Once the challenge image sequence has been displayed to the user in step 145, the user response is received and the input is verified in step 150 to ensure that the correct text or image has been recognised by the user to verify that they are an actual human user to a substantial level of certainty. The process then comes to an end in step 155 with the user either verified as having identified the text or image correctly and therefore being accepted as a human user, or with the use having failed to identify the text or image correctly and not being accepted as a human user, optionally being prompted by the system to make another attempt at verification (i.e. beginning at step 102 of the process again).

An alternative embodiment to the single stack generator uses two “parallel stack generators” and then mixes the output data at the second stage. The advantage of the single stack generator compared to the parallel stack generators can be to improve the speed of production of the sequence of images by at least 75% as well as improving the quality and clarity of the output results.

In order to integrate and superimpose consecutive (image) frames, they must arrive in the human visual system within a delay threshold value not greater than τ≅40 ms in order to use the persistence of vision effect. Thus, by choosing a substantially optimal value for the parameter λ_{θ}, we can make sure that the frequency of appearing fa series 120 is sufficient compared to fb series 135 in a single stack generator 100 in order to make the final output results 145 visible to human's visual system using the persistence of vision effect.

It may be important to choose a substantially optimal value for the λ_{θ} in such a way that two original frames (A-frames) 120 arrive in the stack (also referred to as a pipeline) 130 and are displayed to a user 145 within the accepted inter-stimulus interval (ISI) delay in order for the persistence of vision effect not to “forget” or “lose” the preceding pixel information in a user's brain.

Exceeding the threshold value λ_{θ} can cause a saturation effect, where this effect may weaken the security of the model such that the images can be superimposed by a computer-simulated user to decipher the hidden object. In order to mask the frequency of the pixels, random frames (B-frames) are injected between original frames (A-frames) so that the sequence of image frames are made up of interleaved random and original frames in an unpredictable interleaving arrangement. The probability of A-frames and B-frames appearing will be determined using a substantially optimal threshold value for λ_{θ}. Therefore, the accepted and optimal range for parameter λ depends on the threshold value θ where: λ=θ%; and ˜0.25≤θ≤˜0.45. Therefore, the optimal value for λ_{θ} is: ˜25%≤λ_{θ}≤˜45%.

In this example embodiment the process of rendering sequential images may begin by generating a random number between 0 and 1 referred to as the “seed”. This process of generating a fresh random seed value can be repeated as the process proceed along every single stack cell.

The seed number is then checked against threshold value θ. If the generated random number falls below or is equal to the threshold value θ, then function-A will be called and executed. Alternatively, if the randomly generated value is greater than the threshold value θ, then the system will execute function-B. In at least one embodiment this process will be executed such that producing the output images in sequence, to create a random sequential order, results in a seamlessly presented sequence of images to the end-user.

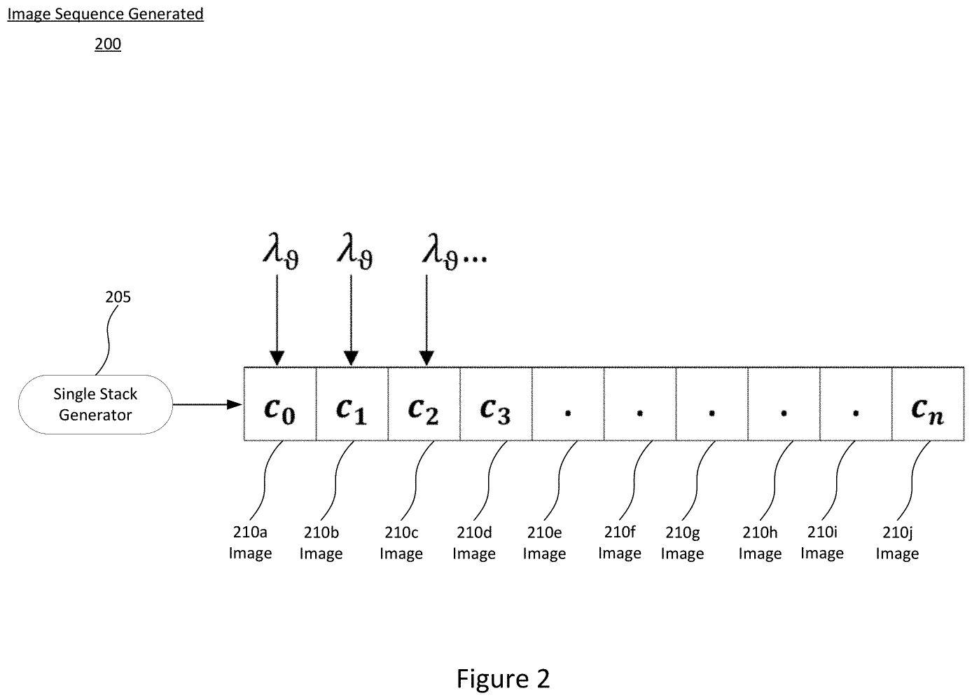

FIG. 2 shows how the sequence of images 210a-j generated by the single stack generator 205, as described above in process 100 of FIG. 1, is displayed to a user to be verified according to an embodiment.

The process of creating the output sequence of images 210a-j is based on generating two series of random images (Image-A and Image-B) with a probability of λ_{θ} (which is the probability of image-A and image-B appearing in a random sequence c₀, c₁, c₂, c₃ . . . cₙ).

The order in which this uniform sequence c₀, c₁, c₂, c₃ . . . cₙ presents an image from the Image-A generation process versus an image from the Image-B generation process should be as unpredictable as possible.

By determining the images 210a-j using the single stack generator 205, the seed generated value determines for each of the images 210a-j in the sequence c₀, c₁, c₂, c₃ . . . cₙ whether each image is an image from the Image-A generation process versus an image from the Image-B generation process. Further, using the single stack generator 205, the image from the Image-A generation process versus image from the Image-B generation process is generated according to the random function with probability λ_{θ}, depending on the generated seed value.

The rendered output rendered frames (images) 210a-j are then shown in the sequence in which they are generated c₀, c₁, c₂, c₃ . . . cₙ to the end-user at a specific frame rate (FPS). The single stack generator 205 generates the series of random unique images and sampled original images 210a-j, the combination of which with the rendered output frames allows a human visual system able to recognise the hidden characters due to the persistence of vision characteristics of the human visual system.

Since each individual image is rendered using a random function, comparing every two consecutive frames using a computer should mean that partial or no information may be retrieved, for example using computer vision and/or optical character recognition techniques. ‘Function-A’ generates a series of “original” images (Image-A) which are uniquely individually generated. The sequence of frames 210a-j is generated in such a way that every individual image has a unique pattern and contains the key elements (data pixels) of the object which is sampled at α rate together with injected background noise at threshold value β rate. Whist ‘Function-B’ generates a series of unique ‘Random’ images (Image-B) that is rendered and sampled based on the value β from Function-A.

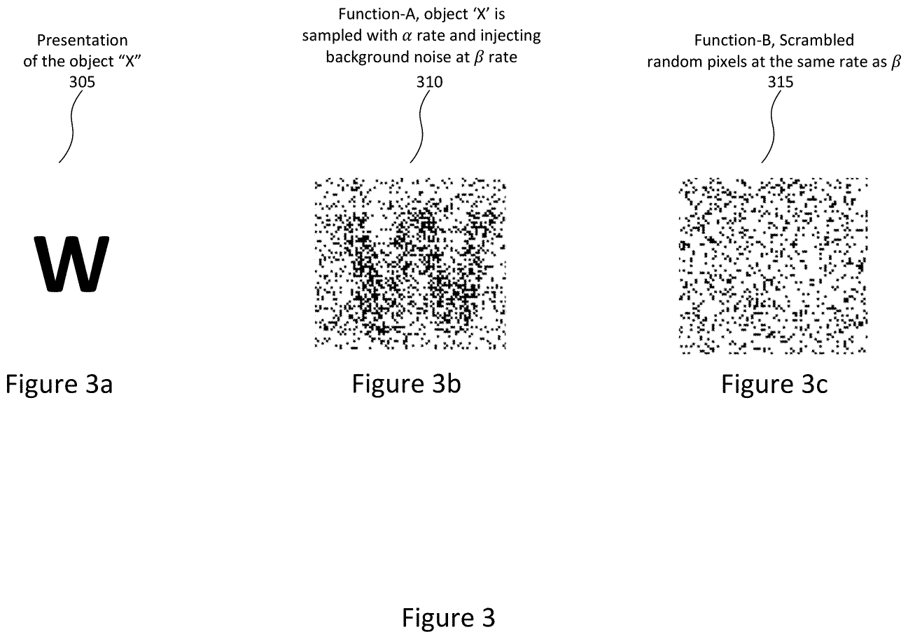

Embodiments will now be described with reference to FIG. 3a to FIG. 3c.

FIG. 3a shows an example original object 305 for a user to recognise, in this example embodiment the character “w”. Alternatively, in other examples, a word or phrase can be displayed or even an image or icon.

FIG. 3b shows a sampled original frame 310, i.e. an image frame containing both pixels belonging to the original object (which represent the recognisable image to be recognised by a user in order to enter a challenge response, so in FIG. 3a the user would be expected to enter “W” as their challenge response for example) which are sampled at the rate of α as well as pixels in the same frame that are generated background noise pixels which are injected randomly at the rate of β.

FIG. 3c illustrates a frame of scrambled random pixels 315 generated at the same rate of β. The final output rendered results are purely random scrambled pixels and so cannot represent the complete information of the object. However, a simulated user or bot will find it very difficult to identify whether each frame in the sequence of frames presented to a user is a frame of scrambled random pixels or a sampled original frame because the information content of each frame will appear to be similar.

The sequence of challenge images comprising both the sampled original images and random noise will ultimately be presented to the user. A human user should be able to recognise the object encoded in the sampled original frames while a simulated user will find it difficult to identify which are the sampled original frames and which are the random noise and will find it extremely hard within the permitted challenge response time to identify the object from the sequence of frames.

Alternatively, in some embodiments, the use of a single colour for the sampled original image and the random noise pixels is used to provide an increased level of complexity and thus an additional layer of security against any computer implemented systems that may attempt to break the verification tool by attempting to learn a correlation between the successive image frames or to determine a pattern. In other embodiments, multiple colours can be used.

As illustrated in FIGS. 3a-3c, as opposed to some conventional methods that rely on segmenting a recognisable image into equal or unequal segments, embodiments herein implement a sampling technique which results in a configurable density of the number of pixels presented in each image frame which can be tailored to correspond to the density functions required to optimally make use of the trans-saccadic memory and sequential human visual perception.

By analysing the output frames individually using a computer, i.e. should a computer-simulated human user attempt to determine the correct challenge response, it should not possible to reform the object image/challenge response. As the output sequence is the combination of original frames plus random frames with the probability of completely random order, an aggregation technique should not work to determine the correct challenge response.

Therefore, a random result is generated which in this case is scrambled pixels. α represents the object sampling rate and β represents the background noise. The relationship between α and β is important, as a greater difference in the threshold values could cause resolving the object pixels into the background noise and the output results cannot be recognised by the human eye.

According to this embodiment, one specific ratio which may be used between a threshold value α and β is defined conventionally as the “Golden Ratio” (GR) which is approximately equal to: GR=1.618. Therefore:

α=1.618β

Having greater ratio than the Golden Ratio would cause the object to be too obvious even to OCR (optical character recognition), whereas a ratio less than the optimal value may not be visible for human users. Therefore, the arrangement would not perform its intended purpose of successfully distinguishing between human and bot users.

An exemplary given threshold range for values of α and β in order to be visible and readable by human eye while remaining ambiguous to a bot is predetermined as:

˜16%≤α≤˜32% and relatively for ˜10%≤β≤˜20%.

λ_{θ} is the probability of a sequence of ‘Original’ frames from function-A (fa) appearing over ‘Random’ frames from function-B (fb) and is defined as below:

$${λ}_{θ} = \frac{probability of ( {f}_{a} )}{probability of ( {f}_{b} )}$$

The threshold value λ_{θ} plays a key role in this equation, since by choosing an out of range value for λ_{θ} the effect of persistence of vision/the trans-saccadic memory could be lost or unreliable and therefore the object to be recognised only by a human user is not be seen by human eyes. The threshold value λ_{θ} at least partially defines inter-stimulus interval (ISI) delay, which is the delay between the offset of the first stimulus and the onset of the next stimulus.

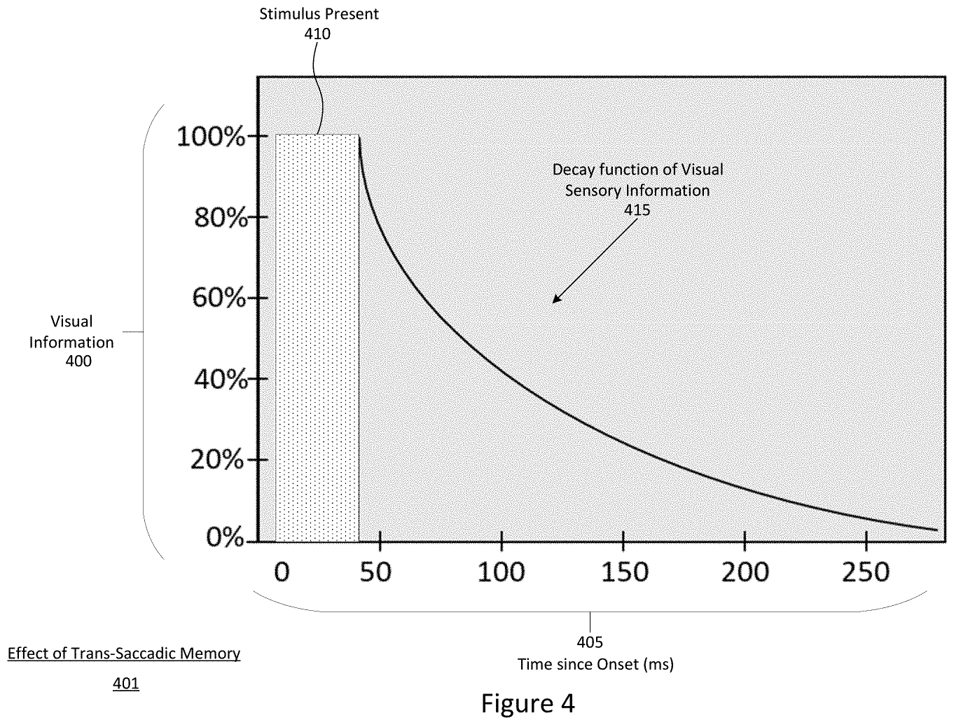

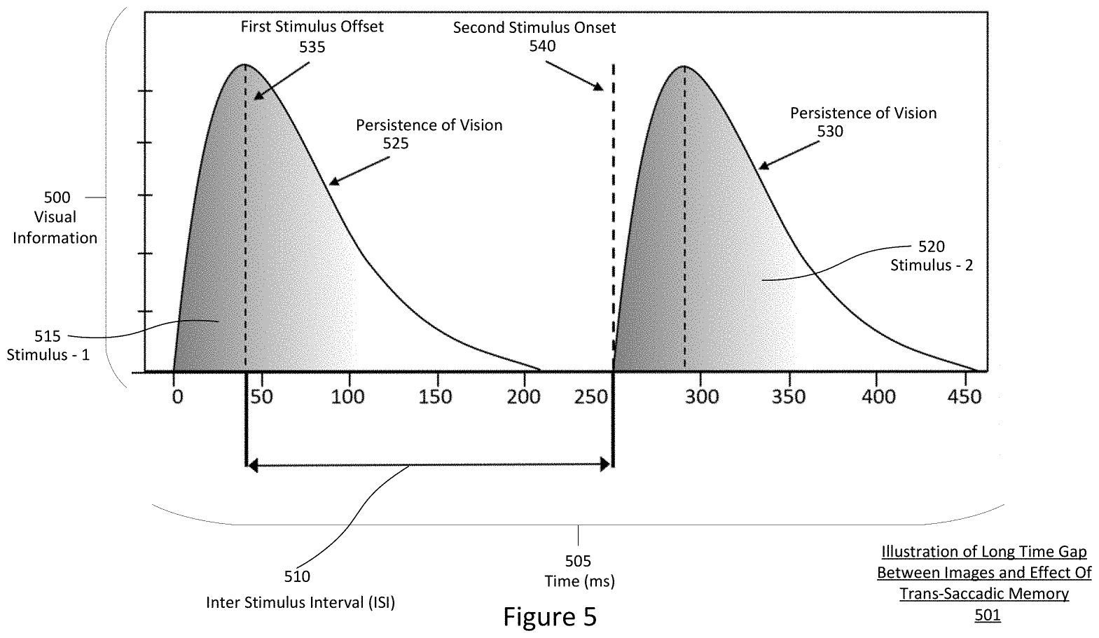

The ability of the human brain to remember and integrate every single image (frame) perceived with the successive perceiving frames in our brain is generally known as the “persistence of vision” effect and uses the trans-saccadic memory. The human visual system depends on inter-stimulus interval as this delay is the main cause of the persistence of vision. λ_{θ} must be selected with care to ensure the inter-stimulus interval delay is at the optimal threshold value. Having a long and out of range inter-stimulus interval delay would cause our brain to forget the visual effect of the preceding frames before next frame arrives in our vision, also referred to as a “Decay function”, and is represented in FIGS. 4 and 5.

FIG. 4 specifically shows a illustration of the decay of visual information over time 401.

Specifically, where a stimulus 410 is shown to a user for a short period of time, the graph shows decay function 415 showing the decay in visual sensory information retained 400 by the optical system/brain of the human viewed of the visual information 410 over time 405 and this shows that by around 250 ms from the stimulus 410 almost no visual information 400 is retained. FIG. 5 specifically shows an example 501 of presenting two stimuli (frames) 515, 520 over a period of time 505, which are displayed “out of range” due to the ISI 510 between these stimuli (frames) 515, 520 being shown to a user, specifically the offset between stimuli 535, 540, being too large thus no persistence of vision effect 525 being present from the first stimulus 535 while the second stimulus 540 is shown to the user (for which the persistence of vision 530 also decays before another stimulus is displayed). As a result of being “out of range”, no persistence of vision effect is created between the images 515, 520.

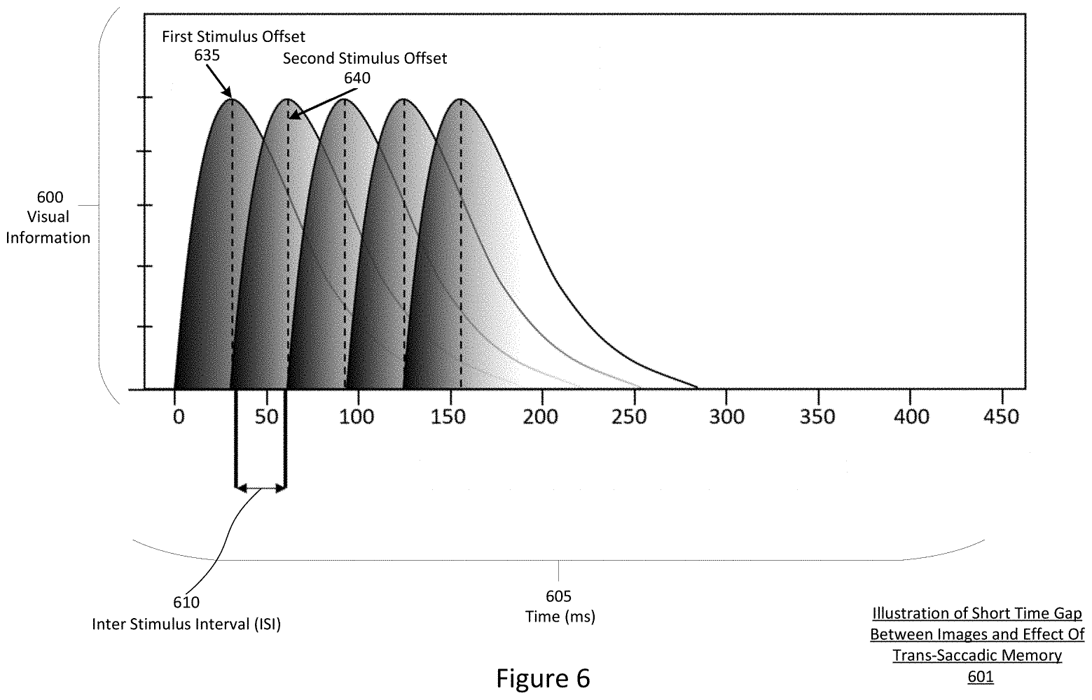

FIG. 6 shows an example of presentation of series of stimulus (frames) 635, 640 arriving where the ISI 610 is within a range that causes persistence of vision effects to be present across a series of images being displayed to a user. Again, the visual information 600 decays over time. For reference, conventional TV or cinema movies use a display rate to viewers of 24 frames per second (FPS). In at least one embodiment, the frame rate at which the sequence of images is displayed to a user is 50 FPS in order to achieve a clearer result to the human eye for the images to be seen by a human user using the persistence of vision effect.

In some embodiments, through the effects of trans-saccadic memory (TSS), each fixation is typically approximately 300-350 ms. As mentioned above, a normal video running at a speed of 24 FPS (frames per second) displays an image at approximately 41 ms a frame. However, present embodiments run at 40 to 50 FPS which displays an image for approximately 25 ms per frame. In doing so, approximately 10 image frames are processed by the human brain per TSS fixation period.

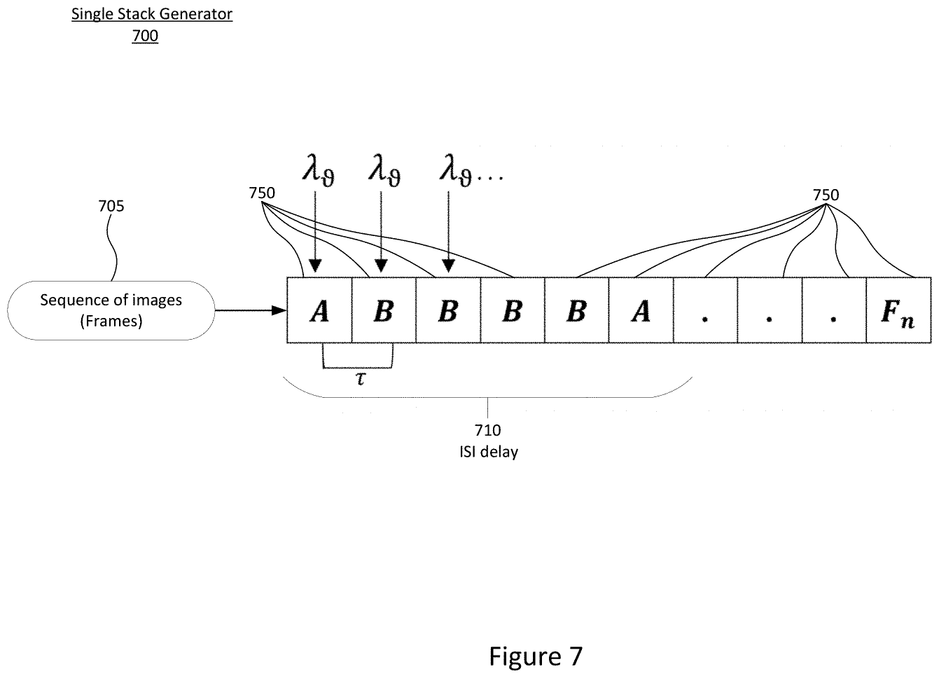

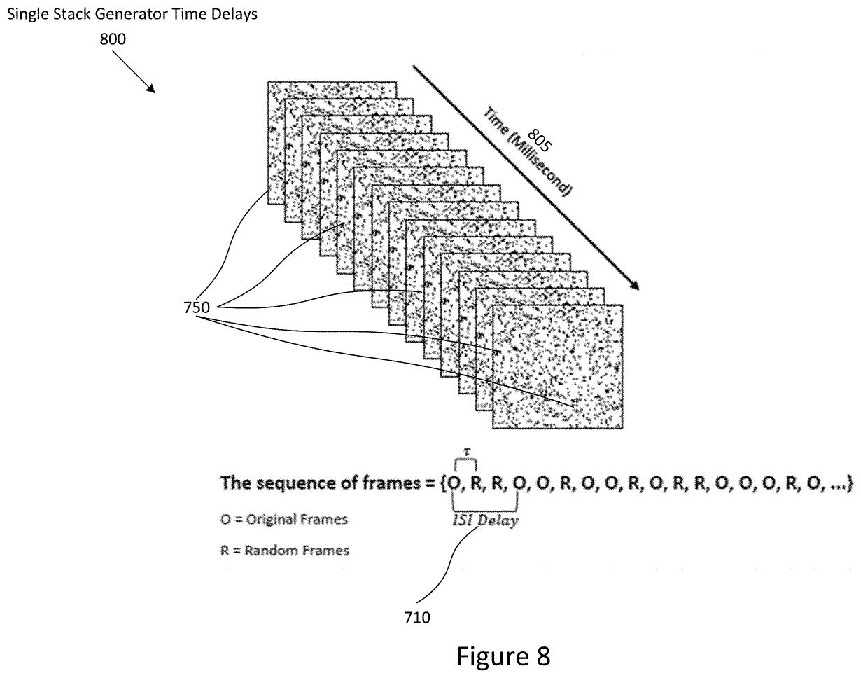

As further represented in FIGS. 7 and 8, the display of the sequence of images 750 over time 805 from the single stack generator 100, 800 will produce the effect of an image to a human viewer, from the original frames A, O using the persistence of vision that can be recognised by a human user, in spite of random frames B, R being randomly interleaved with the original frames A, O that contain the recognisable image to be recognised by the human viewer. This is because the ISI 710 between the original frames A, O means that persistence of vision effects will make it appear to a viewer that there is an image being shown, i.e. the image encoded in the original frames A, O. Because the random frames B, R don't combine to make a recognisable image, the persistence of vision effects won't create a discernible image or text that is seen by the user, they will in effect see “white noise”. In contrast, a computer trying to determine the image being shown in the original frames A, O will not be able to determine which of the sequence of frames 705 are the original frames A, O and which are just random frames B, R as the random frames B, R have been generated using the original frame data but modified to appear to contain the correct amount of information content but not information that contributes to the persistence of vision effect in a human viewer.

It is noted that higher frame rates will also create a higher data bandwidth requirement for the end-user which may affect the output results. The example chosen of a frame rate of 50 FPS produces a time delay (stimulus) of τ≅20 ms between each consecutive frame. An average human's visual system would be able to integrate and superimpose consecutive perceived images (frames) perceived in the visual system if the time delay between those consecutive images (frames) are not greater than 40 ms. This is where the effect of persistence of vision will appear and create an optical illusion in the brain. The output sequence (OS) may be represented as follows:

$$O S = {\sum }_{i = 1}^{n} {c}_{i} \cdot [ {λ}_{θ} ( {f}_{a} ) + ( 100 - {λ}_{θ} ) \cdot ( {f}_{b} ) ]$$

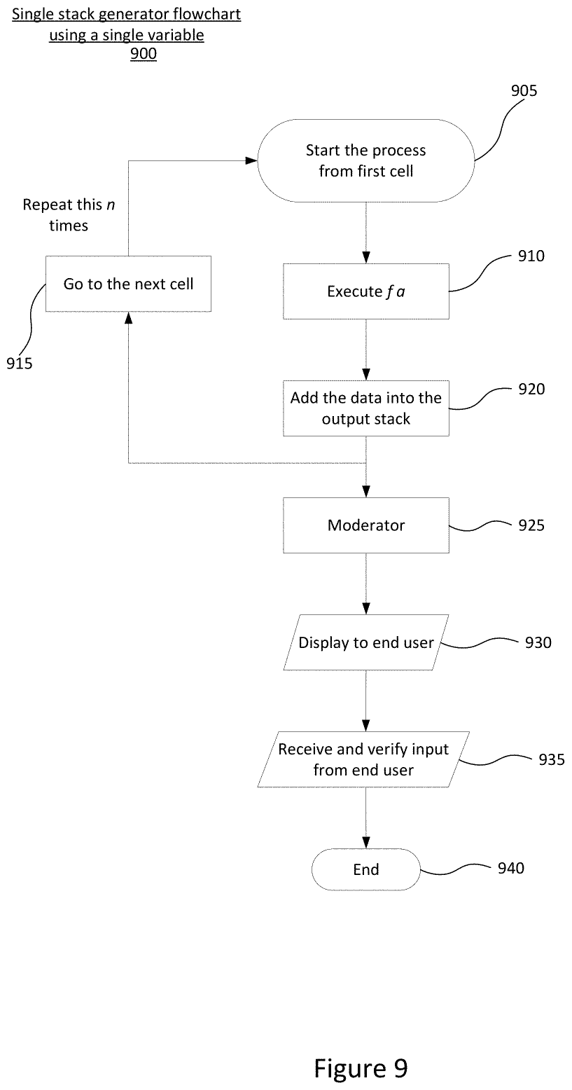

As shown in FIG. 9, an alternative embodiment using a single variable generator may be used instead.

The process described in relation to FIG. 1 may be simplified by removing function-B and only using function-A 910 in the generator 900 to render the sequence of A-images (frames) for display to a user 930.

The process is started in step 905 from a first cell or frame. The next step 910 executes function-A. The data output by function-A 910 is each of the sequence of images to be displayed, and these are added to the “output stack” 920 so that they can be displayed to the user 930. The process then loops back to the next cell 915 the number of times (“n”) required to generate the number of images required to display a full sequence of images 930. Before display to the user 930, the output stack of images is moderated by a moderator step 925, which performs the role described earlier in relation to the moderator module 140 in FIG. 1. An input is then received and verified from the end user in step 935, before the process ends in step 940.

The output sequence of this embodiment may be represented as:

$$OS = {\sum }_{i = 1}^{n} {c}_{i} \cdot [ ( {f}_{a} ) ]$$

In this embodiment, images all contain the information about the main characters (object), and therefore it may be possible for a computer vision system to decipher the letters.

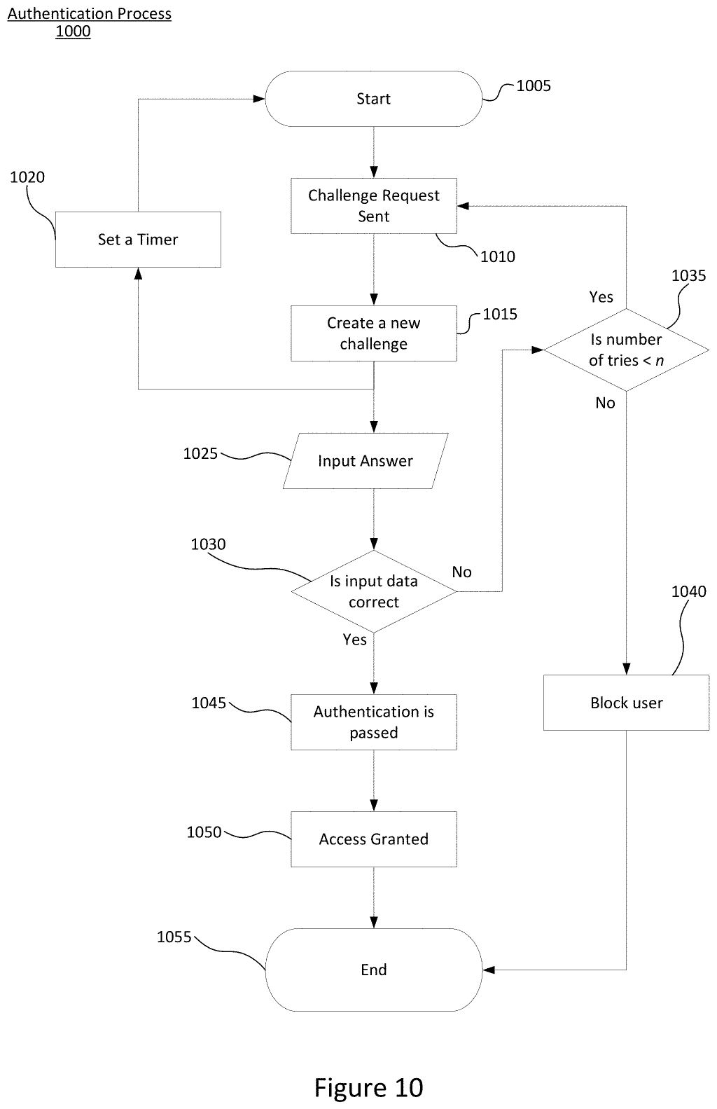

FIG. 10 shows an exemplary authentication process 1000.

The process 1000 begins at step 1005, which is when a user is requesting access to a network. As part of such a request, a challenge request 1010 is sent to a security server 1215. In response to the challenge request 1010, a challenge is produced in step 1015. Each challenge is unique.

Once the challenge is output in step 1015, a timer 1020 monitors the length of time before a response is input to the challenge. If the length of time before a response is input exceeds a predetermined value, then the process begins again at step 1005, and a new challenge may be displayed. This reduces the risk of a bot or similar user recognising the challenge using techniques such as machine learning or pattern recognition.

Following the creation of the challenge in step 1015, an answer 1025 is input by a user. The answer 1025 is reviewed in step 1030 to identify if it is correct, for example if the word provided as part of the challenge created in step 1015 was accurately entered as a response to that challenge. If the answer provided by the user is not correct, the number of attempts (“n”) is reviewed in step 1035. If the number of attempts is less than a predetermined value, for example five attempts, then a new challenge request is sent, and the process reverts to step 1010 for the user to try again with a different challenge. It is appreciated that the required answer to gain access to the network may not be a word, but may be a collection of random letters and/or numbers and/or symbols.

However, if the user provides an incorrect response more than a predetermined number of times, then they might be incapable of answering the challenge and hence should be restricted from access (for example, if they are an automated user or computer simulated user). In such a case the user is blocked in step 1040, and the verification process terminated and their access is restricted or terminated in step 1055. The unauthenticated/unverified user cannot then access the network, nor make any further attempts to do so, within a predetermined time frame.

Alternatively, if the user provides a correct response in step 1025, which is then confirmed in step 1030, they progress to step 1045 at which point the authentication procedure is complete. The user is granted access to the network in step 1050, and hence the process ends in step 1055.

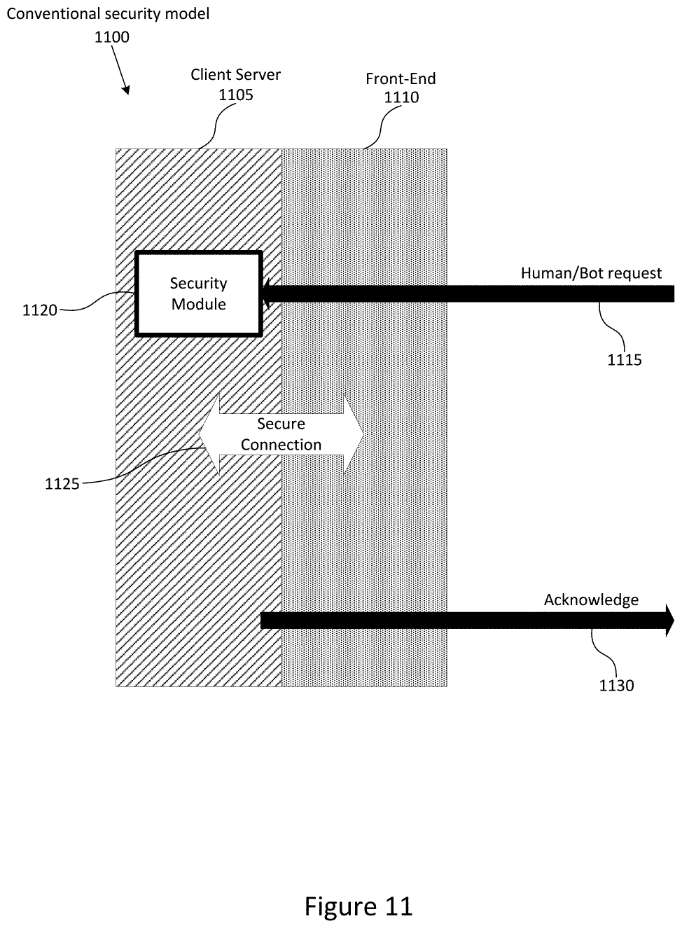

FIG. 11 shows a conventional security model 1100. A client server 1105 is shown, comprising a front-end 1110. A request 1115 for access to a network is made by a user, which may be a bot or a human. The request 1115 reaches a security module 1120 which is part of the client server 1105. The security module 1120 then validates the request 1115, and permits access if the request 1115 was made by an authorised user. The validation of information is performed by the security module 1120 after the request 1115 is already in the client server 1105.

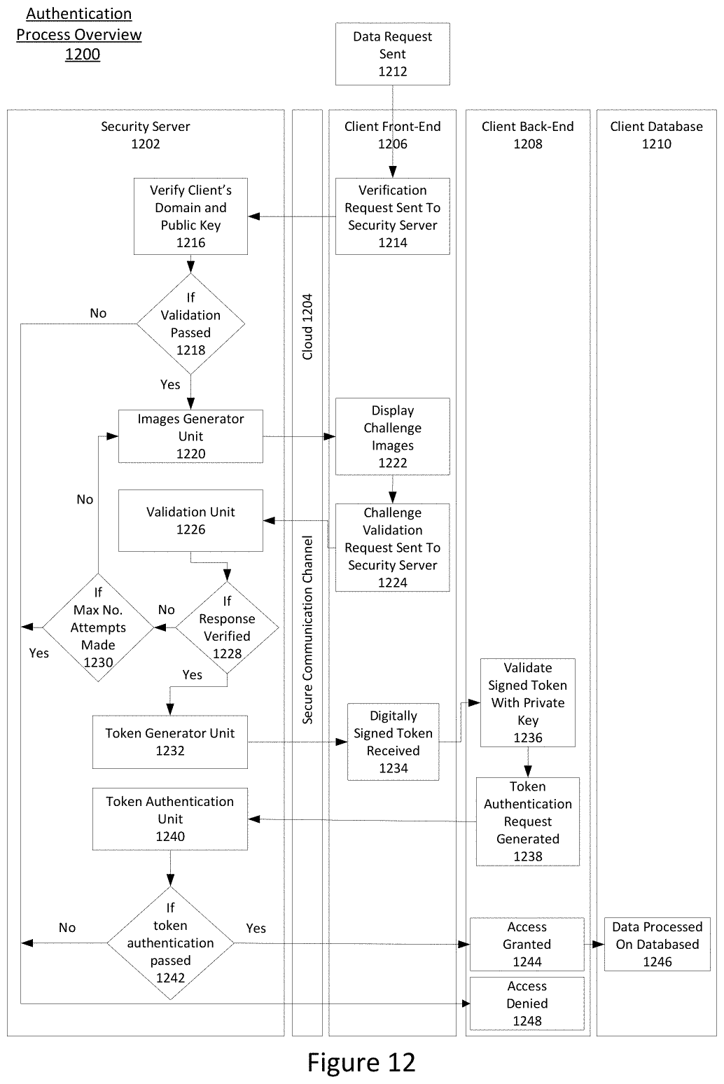

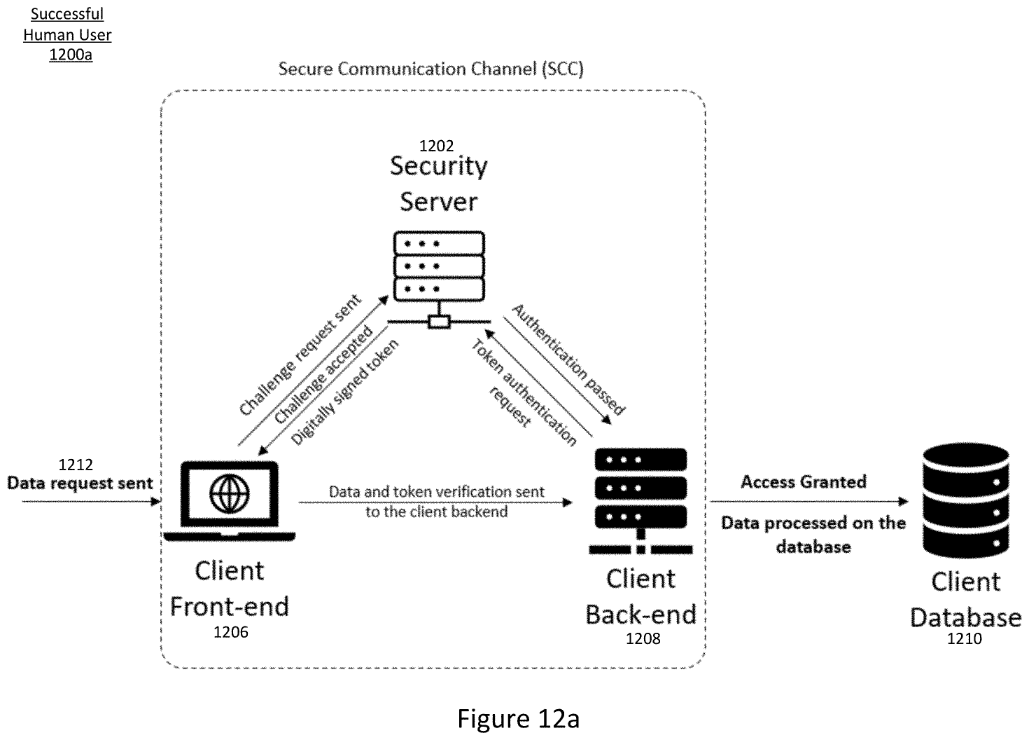

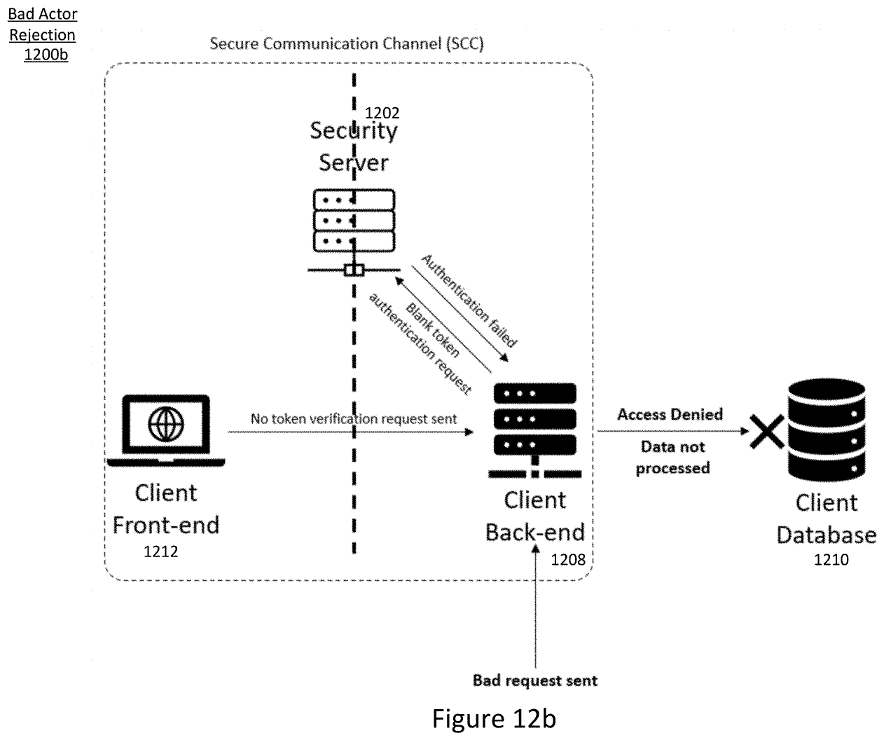

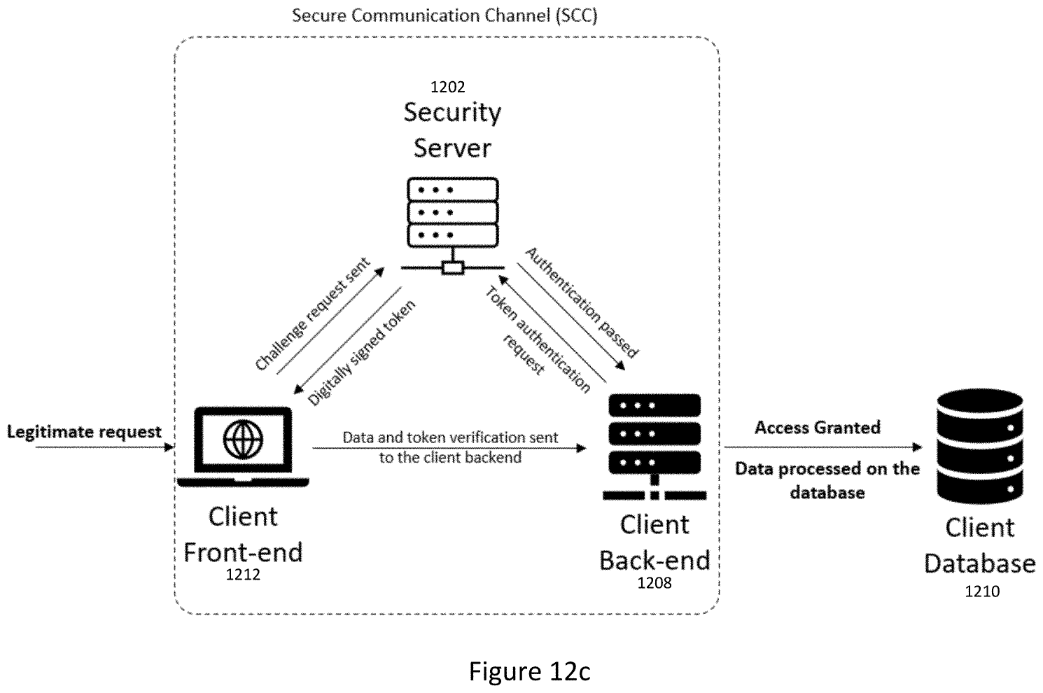

FIG. 12 shows a further embodiment which implements multi-factor authentication 1200 using the verification tool or other embodiments to add a further level of implementational security.

Unlike conventional models, in this embodiment the authenticity of the input data will be checked in a “three-dimensional” way before the data is processed on the client databases 1210. By doing this, the system 1200 can make sure the input data has originated from a legitimate source and the security measures in place cannot be bypassed by any backend API (Application Protocol Interface) or code scripts which are currently used to bypass or spoof the existing verification methods.

The problem with conventional security/verification models is that the security measures can be bypassed using back-end code script since it is usually a vulnerable part of the system. In existing methods, the front-end security can be bypassed by disabling the front-end measures and sending the request using a back-end script code directly to the back-end of the server.

In contrast, the present embodiment ensures that the data request is from a legitimate user and any communication between the various components of the system is not hijacked and/or a faked or spoofed communication channel. This disables malicious users or bots trying to send spam from the front-end of a system using a browser or to send back-end code to the server using script code and instead would only allow legitimate human users to communicate and send data to the database.

Referring to FIG. 12, the novel authentication process 1200 with a token verification will now be described in more detail.

The operations of the security server 1202 can be categorised into three parts or units: 1. A Client Verification Unit, 2. A Challenge Authentication Unit, and 3. A Token Authentication Unit.

First, the client verification unit will be described. A data request 1212 is sent to the client front-end 1206 by either a human user or computer automated software (known as bots). The client front-end 1206 will send a request 1214 to the security server 1202 to authenticate the request by sending a challenge. The security server 1202 will then validate two elements; the client domain name and also the client “public_key” 1216, to ensure that communication is established with a real client and not a fake or hijacked communication.

If the domain name and “public_key” are valid 1218, then the system considers the client to be verified and then moves on to the challenge authentication unit where the system will generate a challenge using an image generator unit 1220 and send it to the client front-end 1206 to be verified by the user. If the domain name and/or public key are not valid 1218 then access is denied 1248.

Next, the challenge authentication unit will be described. After the user is presented with the challenge 1222, the user will need to resolve the challenge presented by, as an example, inputting the expected response into to their browser at the client front-end 1206. The response to the challenge will then be sent 1224 back to the security server for validation 1226.

The response, or the validation request 1224, is received by a validation unit 1226 at the security server 1202. If the input response is considered valid and verified 1228, then it is considered that the user is legitimate, and a human user. However, if the response is not valid 1230, the system will generate another challenge by repeating the same process until a certain threshold is met. If the number of attempts exceeds the threshold 1230 then access will be denied and blocked 1248.

If the response provided by the user is valid 1228, the security server 1202 will move onto the final stage, known as the token authentication unit.

The token authentication unit will now be described. In the security server 1210, the system will generate a one-time encrypted token (OTT) using a token generator unit 1232 and sends this digitally signed token to the client front-end 1234. This encrypted token is digitally signed using a security server signature key specifically made for a particular domain (for example a specific website) and it is valid only for one-time use.

This encrypted token will then be passed to the back-end verification module of the client 1208 where the client's “private_key” (or “secret_key”) will be added to the token 1236. The updated token verification request 1238 will be sent to the security server 1202 to verify the authenticity of the encrypted token with the client “secret_key” 1236 which is received and checked by a token authentication unit 1240.

If the token authentication process is passed and is considered to be valid 1242, access will be granted 1244 to the client back-end 1208 and the data requested can then be processed successfully on the client database 1246. However, if the token authentication process fails, the requested data will be aborted and will not be permitted access to the client database 1248. Furthermore, once a token has been used and verified for a client request, it cannot be used again for another client and as a result, this method is impenetrable and resistant against abuse or multiple attacks by bots using a prior single successful human verification.

FIG. 12a depicts the authentication process 1300 with a token verification process for a legitimate human user 1200a.

As seen in the figure, the data request 1212 is sent to the client front-end 1206 and after verifying the challenge images generated by the security server 1202 the digitally signed token is sent to the client front-end 1206. The token validation will be completed by sending the token to the client back-end 1208 to be verified with the client “private_key”. Finally, the token will be sent back to the security server 1202 for the final verification. In this example, since the data request was generated by a legitimate human user, the token authentication process will be successful, and access will be granted to access/store the data on the database 1210.

FIG. 12b shows a bad actor trying to bypass the security measures implemented by present embodiments 1200b.

A bad actor tries to achieve access to the client database 1210 by sending a modified request directly to the client back-end 1208 using API or code script. If this occurs in the present embodiments, no challenge request will be sent to the security server 1202 because the client front-end 1212 is not engaged, and consequently no token will be generated. Thus, the client back-end 1208 security module will process a “Blank Token request” and send it to the security server 1202. The blank token request will be generated by the client back-end token security module if either no token is generated by the security server which indicates that the client front-end was disabled, or if the domain name or the client “public_key” is invalid. Thus the bad actor is prevented from accessing the client database 1210.

FIG. 12c shows an alternate embodiment to automatically verify the token verification and authentication once the user is recognised as a legitimate user, for example once they have successfully been verified as human using the human verification techniques of other aspects and/or embodiments herein. This method will monitor the user behaviour with the online service provider and, as long as the user behaviour stays within a “Normal” threshold, the security check and authentication process will be automatically verified without any action from the user (i.e. without needing to be verified repeatedly using the human verification techniques by correctly entering the challenge response).

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. A method of determining whether a user on a client device is human or simulated, wherein the following computer implemented method is performed by a server:
receiving a challenge request, wherein the challenge request comprises a request from the client device to send a challenge to the user of the client device;
generating substantially instantaneously, in response to the challenge request, a sequence of challenge images for transmission, wherein generating the sequence of challenge images comprises:
generating a sequence of original images comprising samples of a recognisable image, wherein each of the sequence of original images comprises a unique pattern of pixels;
generating a plurality of random images, wherein each of the plurality of random images comprises scrambled random pixels; and
interleaving the sequence of original images and the random images wherein the recognisable image is recognisable by sequential human visual perception when the sequence of challenge images are observed by a human user;
transmitting each of the sequence of challenge images to the client device substantially instantaneously following generation of each of the sequence of challenge images;
receiving a response to the transmitted sequence of challenge images from the client device; and
determining whether the user of the client device is human or simulated from the received response being correct or incorrect.

2. The method of claim 1, wherein the original images and/or recognisable image comprise any one or any combination of: a word; one or more letters; one or more numbers; a combination of random letters and numbers; a Completely Automated Public Turing test to tell Computers and Humans Apart (CAPTCHA) sample; a mathematical problem; a word problem; a social media link; a timer; and/or a honeypot arrangement.

3. The method of claim 1, wherein the recognisable image is sampled at a predetermined rate to create a sequence of original images.

4. The method of claim 1, wherein the plurality of random images are generated through the use of a random function.

5. The method of claim 1, wherein the rate at which the recognisable image is sampled and the rate at which background noise is injected into the plurality of original images correspond to a fixed ratio, optionally, the fixed ratio is the Golden Ratio to within a predetermined level of tolerance.

6. (canceled)

7. The method of claim 1, further comprising:
generating a seed value, comprising a random number between 0 and 1;
comparing the seed value to a threshold value; and
if the seed value is below or equal to the threshold value, generating one of the sequence of original images; else if the seed value is above the threshold value, generating one of the random images.

8. The method of claim 7, wherein the probability of generating the one of the sequence of original images is between 25% and 45%.

9. The method of claim 1, wherein the delay in display between a first and subsequent original image to the user is less than 40 milliseconds.

10. The method of claim 1, further comprising:
transmitting, in response to the request for a challenge image, one or more further sequences of challenge images to the client.

11. The method of claim 10, wherein the one or more further sequences of challenge images are presented substantially concurrently to an initial set of challenge images.

12. method of claim 1, wherein the challenge request comprises validating The at least a client domain name and a client public key.

13. The method of claim 1, further comprising generating an encrypted token upon validating the response to the transmitted sequence of challenge images from the client device.

14. The method of claim 13, wherein the encrypted token is a one-time use token and is digitally signed using a signature key corresponding to the server.

15. The method of claim 14, further comprising:
sending the encrypted token to the client device;
receiving from the client device an updated encrypted token comprising a signature key of the client device; and
verifying the authenticity of the updated encrypted token.

16. A computer implemented method of determining between a human user and simulated user, comprising the following steps:
selecting at least one recognisable image;
generating a sequence of original images comprising samples of the recognisable image;
generating, substantially instantaneously, a sequence of challenge images based on a first plurality of first images and a second plurality of second images, wherein the sequence of challenge images comprises a substantially interleaved sequence of the first plurality of first images and the second plurality of second images;
wherein, the first plurality of first images comprises the sequence of original images; wherein, the second plurality of second images comprises a plurality of random noise images; and
displaying the sequence of challenge images in a manner to cause the recognisable image to be recognisable by sequential human visual perception, when the sequence of challenge images are observed by a human user;
capturing the input from the user; the input comprising the user impression of the recognisable image; and
outputting a verification result based on whether the user input matches the recognisable image.

17. The method of claim 13, further comprising:
sending the encrypted token to the client device;
receiving from the client device an updated encrypted token comprising a signature key of the client device; and
verifying the authenticity of the updated encrypted token.
